(19) United States
(12) Patent Application Publication
(10) Pub. No.: US 2025/0321125 A1
(43) Pub. Date: Oct. 16, 2025

(54) MAGNETIC POLE POSITION DETERMINING SYSTEM AND METHOD

(71) Applicant: QINGDAO HISENSE HITACHI AIR-CONDITIONING SYSTEMS CO., LTD., Shandong (CN)

(72) Inventors: Jinwei ZHOU, Qingdao (CN); Xuexiang JIANG, Qingdao (CN); Xizhi Ll, Qingdao (CN); Zhaoting REN, Qingdao (CN)

(73) Assignee: QINGDAO HISENSE HITACHI AIR-CONDITIONING SYSTEMS CO., LTD., Shandong (CN)

(21) Appl. No.: 19/246,702

(22) Filed: Jun. 24, 2025

Related U.S. Application Data
(63) Continuation of application No. PCT/CN2024/075271, filed on Feb. 1, 2024.

(30) Foreign Application Priority Data
Feb. 27, 2023 (CN) 202310173341.8

(51) Int. Cl. G01D 5/20

(52) U.S. Cl. CPC G01D 5/2013

(57) ABSTRACT

The present disclosure provides a magnetic pole position determining system, including a motor and a magnetic pole position determining apparatus. The motor includes a rotor. The apparatus is configured to: apply a high-frequency voltage to a direct axis of a two-phase rotating coordinate system of the motor at a first time point; determine a magnetic pole initial position of the rotor and a rotating speed of the rotor based on the high-frequency voltage; apply a zero voltage vector pulse to the motor at a second time point; determine a current vector position angle corresponding to the zero voltage vector pulse; and determine a magnetic pole position of the rotor based on the first time point, the second time point, the rotating speed of the rotor, the current vector position angle, a preset mapping table, and the magnetic pole initial position.

### CROSS-REFERENCE TO RELATED APPLICATION

This application is a continuation of international application of PCT application serial no. PCT/CN2024/075271 filed on Feb. 1, 2024, which claims priority benefit of China application no. 202310173341.8 filed on Feb. 27, 2023. The entirety of each of the above-mentioned patent applications is hereby incorporated by reference herein and made a part of this specification.

### BACKGROUND

### Technical Field

The present disclosure relates to the field of motor control technologies, and in particular, to a magnetic pole position determining system and a magnetic pole position determining method.

### Description of Related Art

Permanent-magnet synchronous motors are widely used in aerospace, industrial transmission, household appliances, and other scenarios as electromechanical energy conversion devices. With the advantages of simple structure, small size, light weight, high efficiency, and the like, the permanent-magnet synchronous motor has become a research hotspot in the field of alternating current speed regulation transmission. In the permanent-magnet synchronous motor, precise rotor magnetic pole position and speed signals are required to realize magnetic field orientation and speed control.

### SUMMARY

In an aspect, a magnetic pole position determining system is provided. The magnetic pole position determining system includes a motor and a magnetic pole position determining apparatus. The motor includes a rotor. The magnetic pole position determining apparatus is coupled to the motor. The magnetic pole position determining apparatus is configured to:
apply a high-frequency voltage to a direct axis of a two-phase rotating coordinate system of the motor at a first time point;
determine a magnetic pole initial position of the rotor and a rotating speed of the rotor based on the high-frequency voltage;
apply a zero voltage vector pulse to the motor at a second time point; determine a current vector position angle corresponding to the zero voltage vector pulse;
determine a rotation position of the magnetic pole at the second time point based on a time difference between the first time point and the second time point, the rotating speed of the rotor, and the magnetic pole initial position;
determine a reference quadrant where the direct axis is located at the second time point based on the current vector position angle and a preset mapping table, where the preset mapping table stores a correspondence between the current vector position angle and a quadrant in which the magnetic pole of the rotor is located, and the quadrant is a quadrant formed by axes of a two-phase stationary coordinate system of the motor; and
determine a magnetic pole position based on the reference quadrant where the direct axis is located at the second time point and the rotation position of the magnetic pole at the second time point.

In another aspect, a magnetic pole position determining method is provided. The method is applied to a motor. The motor includes a rotor, and the rotor includes a magnetic pole. The determining method includes:
applying a high-frequency voltage to a direct axis of a two-phase rotating coordinate system of the motor at a first time point;
determining a magnetic pole initial position of the rotor and a rotating speed of the rotor based on the high-frequency voltage;
applying a zero voltage vector pulse to the motor at a second time point;
determining a current vector position angle corresponding to the zero voltage vector pulse;
determining a rotation position of the magnetic pole at the second time point based on a time difference between the first time point and the second time point, the rotating speed of the rotor, and the magnetic pole initial position;
determining a reference quadrant where the direct axis is located at the second time point based on the current vector position angle and a preset mapping table, wherein the preset mapping table stores a correspondence between the current vector position angle and a quadrant in which the magnetic pole of the rotor is located, the quadrant being a quadrant formed by axes of a two-phase stationary coordinate system of the motor; and
determining a magnetic pole position based on the reference quadrant where the direct axis is located at the second time point and the rotation position of the magnetic pole at the second time point.

### BRIEF DESCRIPTION OF THE DRAWINGS

FIG. 1 is a schematic diagram of a structure of a magnetic pole position determining system according to some embodiments.

FIG. 2 is a schematic diagram of a motor according to some embodiments.

FIG. 3 is a schematic diagram of another motor according to some embodiments.

FIG. 4 is a flow chart of steps performed by the magnetic pole position determining system according to some embodiments.

FIG. 5 is a schematic diagram of a rotating coordinate system for a high-frequency square wave injection method according to some embodiments.

FIG. 6 is a phase diagram of a zero-voltage vector single-pulse method according to some embodiments.

FIG. 7 is another flow chart of steps performed by the magnetic pole position determining system according to some embodiments.

FIG. 8 is yet another flow chart of steps performed by the magnetic pole position determining system according to some embodiments.

FIG. 9 is yet another flow chart of steps performed by the magnetic pole position determining system according to some embodiments.

FIG. 10 is a graph of a current vector versus a magnetic pole position when a rotor rotates in a first direction according to some embodiments.

FIG. 11 is a graph of a current vector versus a magnetic pole position when the rotor rotates in a second direction according to some embodiments.

FIG. 12 is a verification diagram corresponding to a magnetic pole position determining method according to some embodiments.

FIG. 13 is another verification diagram corresponding to the magnetic pole position determining method according to some embodiments.

FIG. 14 is an architectural diagram corresponding to the magnetic pole position determining method according to some embodiments.

FIG. 15 is a structural view of a magnetic pole position determining apparatus according to some embodiments.

FIG. 16 is a schematic circuit structure of a motor according to some embodiments.

### DESCRIPTION OF THE EMBODIMENTS

Some embodiments of the present disclosure are clearly and completely described below with reference to the accompanying drawings, and apparently, the described embodiments are not all but only a part of the embodiments of the present disclosure. All other embodiments obtained by a person of ordinary skill in the art based on the embodiments of the present disclosure shall fall within the protection scope of the present disclosure.

Unless required otherwise in the context, throughout the specification and the claims, the term “comprise” and its other forms such as “comprises” and “comprising” are interpreted as open and inclusive meaning “including, but not limited to”. In the description of the specification, the terms “one embodiment”, “some embodiments”, “exemplary embodiments”, “example”, “specific example”, “some examples”, or the like, are intended to indicate that a particular feature, structure, material, or characteristic in connection with the embodiment or example is included in at least one embodiment or example of the present disclosure. The schematic representations of the above terms do not necessarily refer to the same embodiment or example. In addition, the particular feature, structure, material, or characteristic may be included in any suitable manner in any one or more embodiments or examples.

Hereinafter, the terms such as “first” and “second” are used herein for purposes of description and are not intended to indicate or imply relative importance or significance or to imply the number of indicated technical features. Thus, the feature defined with “first” and “second” may include one or more of this feature explicitly or implicitly. In the description of the embodiments of the present disclosure, “a plurality” means two or more unless otherwise specified.

In describing some embodiments, the expressions “coupled” and “connected” along with their derivatives may be used. The term “connected” is to be interpreted broadly, and for example, “connected” may be a fixed connection, a detachable connection, or an integral connection; may be a direct connection or indirect connection via an intermediate medium. For example, the term “coupled” indicates that two or more components are in direct physical or electrical contact. The terms “coupled” or “communicatively coupled” may also mean that two or more components are not in direct contact with each other, but yet still cooperate or interact with each other. The embodiments disclosed herein are not necessarily limited to the contents herein.

“A and/or B” includes the following three combinations: A alone, B alone, and a combination of A and B.

The use of “adapted to” or “configured for” herein means open and inclusive languages and does not exclude devices adapted to or configured for performing additional tasks or steps.

Additionally, since a process, step, calculation, or other action that is “based on” one or more stated conditions or values may, in practice, be based on additional conditions or exceed the stated values, the use of “based on” is open and inclusive.

Hereinafter, terms involved in the present disclosure are described.

A cut-off frequency refers to a frequency obtained by changing the frequency to reduce an output signal to 0.707 times of a maximum value when an amplitude of an input signal is kept unchanged, namely, a frequency at which the point of −3 dB is expressed by a frequency response characteristic, and the cut-off frequency is configured to be a special frequency for explaining a frequency characteristic index. In addition, the cut-off frequency further refers to a boundary frequency (usually bounded by −3 dB) at which energy of the output signal of a system begins to fall or rises in a band-stop filter.

Low-pass filtering, also called high-cut filtering or treble-cut filtering, is a filtering method which has the filtering rule that a low frequency signal with a frequency smaller than the cut-off frequency can normally pass, a high-frequency signal with a frequency larger than the cut-off frequency is blocked and weakened in a filtering process, and a blocking and weakening degree of the high-frequency signal can be changed according to different frequencies and different filtering programs (purposes).

A low-pass filter refers to an electronic filtering apparatus that allows the signal with the frequency smaller than the cut-off frequency to pass, but does not allow the signal with the frequency larger than the cut-off frequency to pass.

A Park's transformation is a most commonly used coordinate transformation for analyzing operation of a synchronous motor. In the Park's transformation, a, b and c three-phase currents of a stator are projected to a direct axis (d-axis) rotating with a rotor, a quadrature axis (q-axis) and a zero axis (0-axis) perpendicular to a d-q plane, i.e., an abc coordinate system is transformed to a d-q coordinate system, so that diagonalization of a stator inductance matrix is realized, and the operation analysis of the synchronous motor is simplified.

A permanent-magnet synchronous motor (PMSM) refers to a synchronous motor in which a winding of a rotor is replaced with a permanent magnet.

A proportional-integral (PI) controller is a linear controller that forms a control deviation based on a given value and an actual output value, and linearly combines the proportion and the Integral of the deviation to generate a control signal, thereby controlling a controlled object.

A transfer function refers to a ratio of a Laplace transformation (or z-transformation) of a response quantity (i.e., output quantity) to a Laplace transformation of an excitation quantity (i.e., input quantity) of a linear system under a zero initial condition. The transfer function is denoted as G(s)=Y(s)/U(s), where Y(s) and U(s) are the Laplace transformations of the output quantity and the input quantity respectively.

In motion control of the permanent-magnet synchronous motor, a precise magnetic pole position signal and a precise speed signal of the rotor are required to realize magnetic field orientation and speed control of the rotor. In sensorless vector control of the permanent-magnet synchronous motor, incorrect identification of the magnetic pole positions (i.e., south pole (S pole) and north pole (N pole)) of the rotor may cause the rotor to rotate in the reverse direction or lead to failure of the PMSM startup when the PMSM is started, and may also affect an operation performance of a system (e.g., air conditioning system) including the permanent-magnet synchronous motor after it is started.

However, high performance vector control relies on accurate rotor magnetic pole position and speed feedback. In some embodiments, a system that performs vector control typically implements detection of the magnetic pole position of the rotor by means of a photoelectric encoder, a rotary transformer, or the like, which affects a weight reduction and reliability of the system including the permanent-magnet synchronous motor. In the sensorless vector control of the permanent-magnet synchronous motor, observation of the magnetic pole position of the rotor is realized by acquiring parameters (such as current or voltage) of the permanent-magnet synchronous motor, so that a cost can be reduced, and the reliability can be improved. However, for an apparatus (such as an air conditioner fan) in which the rotor may be already in a rotating state before starting and the rotating speed is low, it is necessary to determine a magnetic pole initial position and the rotating speed of the rotor, and then apply the determination result to the sensorless vector control. Therefore, accurate determination of the magnetic pole initial position and the rotating speed is a precondition for realizing the sensorless vector control.

In the related art, a double-pulse method is used to solve the technical problem of identifying the magnetic pole position of the rotor at a low rotating speed. For example, in the double-pulse method, a first voltage pulse and a second voltage pulse are required to be sequentially injected into d-axis and −d-axis directions (as shown in FIG. 6), and the identification of the magnetic pole position is realized according to a current response. However, in the double-pulse method, the second voltage pulse needs to be injected at a predetermined time interval after the first voltage pulse is injected, and in the case where the rotor of the permanent-magnet synchronous motor rotates, the rotor may rotate by a certain angle within the predetermined time interval, so that an injection direction of the second voltage pulse is incorrect, which affects the accuracy of the identification of the magnetic pole position.

In the related art, a d-axis current peak value accumulation method is used to identify the magnetic pole position of the rotor in a static state. It should be noted that the d-axis current peak value accumulation method includes: extracting and accumulating d-axis current peak value signals in the high-frequency voltage signal injection process, and identifying the magnetic pole position by determining whether the accumulated value is positive or negative. However, the method requires a long time to identify the magnetic pole position of the rotor, resulting in a long process of identifying the magnetic pole position.

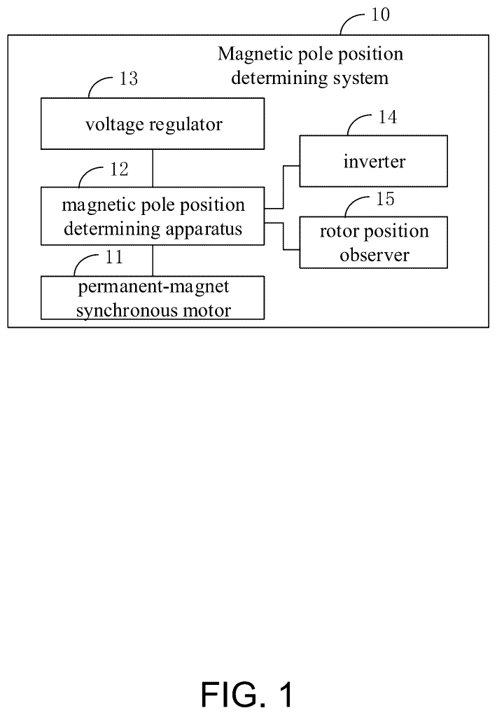

In order to solve the above problem, as shown in FIG. 1, the present disclosure provides a magnetic pole position determining system 10. The magnetic pole position determining system 10 includes a motor 11 and a magnetic pole position determining apparatus 12. The motor 11 is coupled to the magnetic pole position determining apparatus 12.

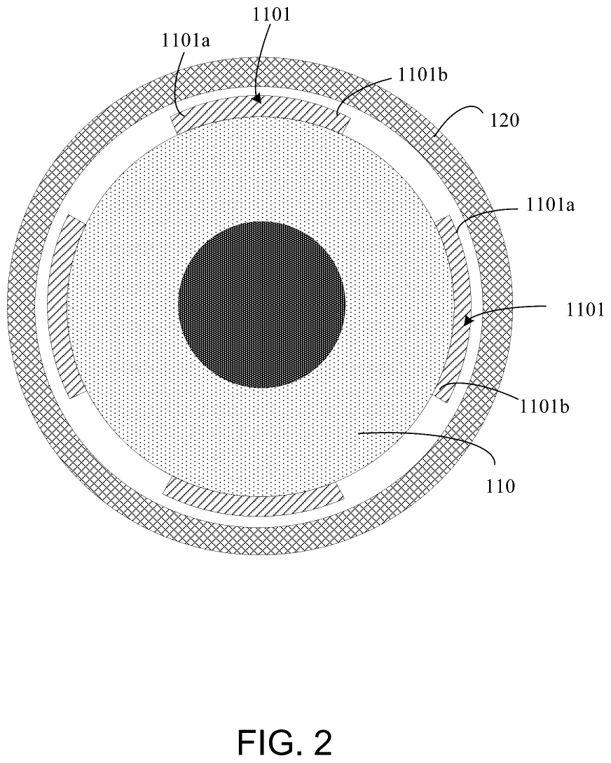

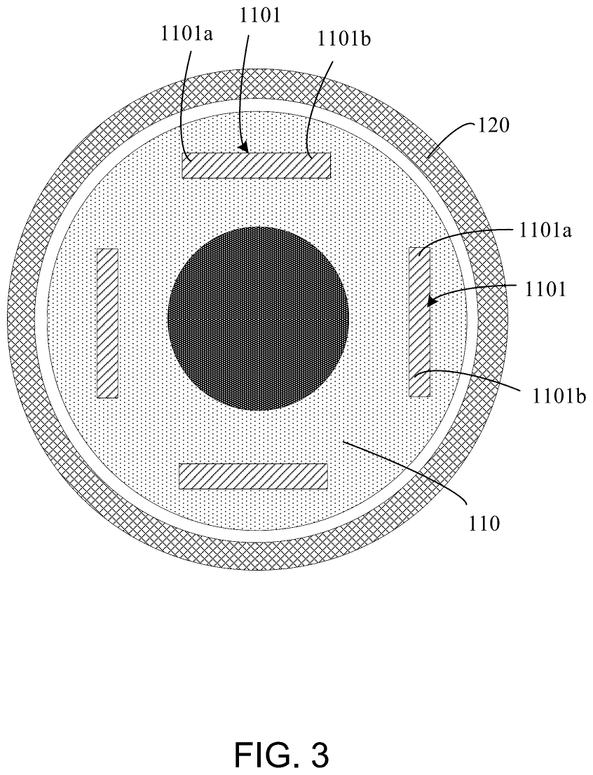

In some embodiments, the motor 11 is, for example, a permanent-magnet synchronous motor. As shown in FIG. 2 and FIG. 3, the motor 11 includes a rotor 110, and the rotor 110 includes, for example, a magnetic pole 1101 and a rotor core. In some embodiments, as shown in FIG. 2, the motor 11 is, for example, a surface-mounted permanent-magnet synchronous motor, i.e., the magnetic pole 1101 is mounted on a surface of the rotor core. In some other embodiments, as shown in FIG. 3, the motor 11 is, for example, a built-in permanent-magnet synchronous motor, i.e., the magnetic pole 1101 is arranged inside the rotor core.

In some embodiments, as shown in FIG. 2 and FIG. 3, the motor 11 further includes a stator 120, the stator 120 being, for example, a stator coil. The stator 120 is configured to generate a rotating magnetic field, such that the rotor 110 cuts the magnetic lines of force in the rotating magnetic field to generate a current. The stator 120 includes a stator core and a stator winding. Here, the stator winding is, for example, a stator three-phase winding.

In some embodiments, the magnetic pole position determining apparatus 12 is configured to: determine a magnetic pole position of the rotor 110 based on one or more of a first time point, a second time point, a rotor rotating speed, a current vector position angle, a preset mapping table, and a magnetic pole initial position. The preset mapping table stores a correspondence between current vector position angles and a quadrant in which the magnetic pole of the rotor 110 is located, the quadrant being a quadrant where the d-axis of the rotor and the q-axis of the rotor are located.

In this way, the magnetic pole position of the rotor 110 can be accurately determined, thereby improving accuracy of identification of the magnetic pole position of the rotor 110 at a low rotating speed. It should be noted that the magnetic pole position determining system 10 may further include a space vector pulse width modulation (SVPWM) arithmetic apparatus and a three-phase thin film capacitor driving apparatus.

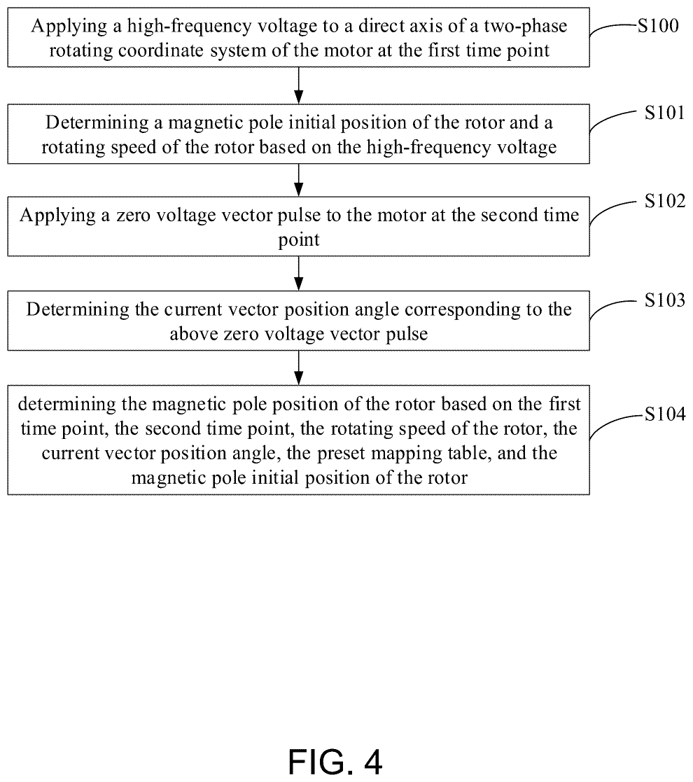

In order to improve the grid-side power quality, in some embodiments of the present disclosure, a method for determining the magnetic pole position of the rotor 110 is provided and applied to the magnetic pole position determining apparatus 12, as shown in FIG. 4, and in some embodiments, the method includes S100-S104.

At S100, a high-frequency voltage is injected (applied) to a direct axis (d-axis) of a two-phase rotating coordinate system of the motor 11 at a first time point t1.

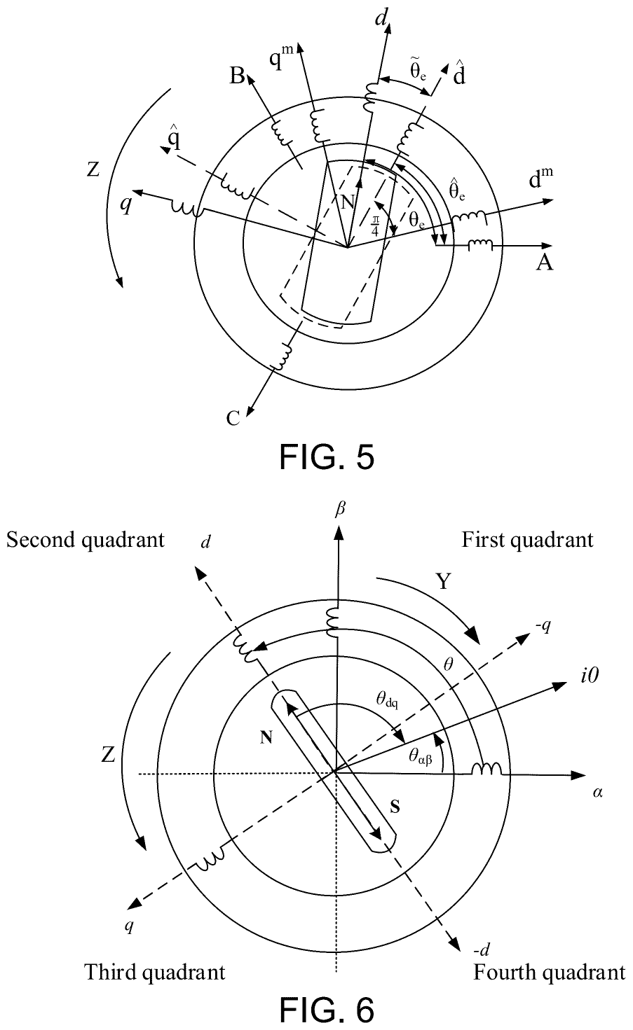

FIG. 5 shows a phase relationship of an ABC coordinate system (three-phase stationary coordinate system), a d-q coordinate system (two-phase rotating coordinate system), a \hat{d}-\hat{q} coordinate system (i.e., observation coordinate system), and a d^{m}-q^{m} axis system (i.e., measurement coordinate system). In some embodiments, as shown in FIG. 5, in a first direction of the rotor 110 (e.g., Z direction in FIG. 5), the d^{m}-q^{m} coordinate system lags behind the \hat{d}-\hat{q} coordinate system by 45° (i.e., π/4).

FIG. 6 shows a α-β stationary coordinate system, and in some embodiments, the two-phase stationary coordinate system is, for example, the α-β stationary coordinate system.

In some embodiments, a signal of the high-frequency voltage injected into the direct axis of the two-phase rotating coordinate system of the motor 11 is a square wave signal with symmetric positive and negative half-cycles, and a mathematical expression thereof is, for example, formula (1):

$${u}_{inj} = \{ \begin{matrix}{U}_{inj} , & t ∈ [ {nT}_{inj} , ( n + \frac{1}{2} ) {T}_{inj} ] \\ - {U}_{inj} , & t ∈ [ ( n + \frac{1}{2} ) {T}_{inj} , ( n + 1 ) {T}_{inj} ]\end{matrix} \qquad formula ( 1 )$$

where Uᵢₙⱼ is an amplitude of the injected high-frequency voltage signal, Tᵢₙⱼ is an injection period of the high-frequency voltage signal, and n is a cycle number of the injected high-frequency voltage signal.

In some embodiments, the frequency of the high-frequency voltage signal is less than or equal to a carrier frequency of the motor.

In some embodiments, the frequency of the high-frequency voltage signal is greater than or equal to 1 Khz, and less than or equal to 2 Khz. For example, the frequency of the high-frequency voltage signal may be 1 Khz, 1.5 Khz, or 2 Khz.

In some embodiments, as shown in FIG. 1, the magnetic pole position determining system 10 further includes a voltage regulator 13. The voltage regulator 13 is coupled to the magnetic pole position determining apparatus 12 and configured to regulate an output voltage of the motor 11.

In some embodiments, the magnetic pole position determining apparatus 12 adds the high-frequency voltage (e.g., the high-frequency square wave voltage) to a d-axis voltage output by the voltage regulator 13.

It should be noted that in some embodiments, the magnetic pole 1101 of the rotor 110 includes a first sub-magnetic pole (e.g., N pole) 1101a and a second sub-magnetic pole (e.g., S pole) 1101b.

At S101, a magnetic pole initial position of the rotor 110 and a rotating speed of the rotor 110 are determined based on the high-frequency voltage.

In some embodiments, as shown in FIG. 1, the magnetic pole position determining system 10 further includes an inverter 14. The inverter 14 is coupled to the magnetic pole position determining apparatus 12 and configured to convert a direct current to an alternating current.

The magnetic pole position determining apparatus 12 obtains the magnetic pole initial position of the rotor 110 and the rotating speed of the rotor 110 according to feedback values of three-phase currents output by the inverter 14.

The feedback values of the three-phase current are actual sampled values of the three-phase current output by the inverter.

As shown in FIG. 5, in some embodiments, θₑ is an actual rotor magnetic pole electrical angle; \hat{θ}ₑ is an observed rotor magnetic pole electrical angle; \tilde{θ}ₑ is a rotor magnetic pole observation error angle. Here, θₑ, \hat{θ}ₑ, and \tilde{θ}ₑ satisfy the following formula: \tilde{θ}ₑ=θe−\hat{θ}ₑ.

In some embodiments, the magnetic pole position determining apparatus is further configured to: obtain a magnetic pole position error signal according to the high-frequency voltage and the feedback values of the three-phase currents output by the inverter. For example, in some embodiments, the high-frequency voltage Uᵢₙⱼ is injected into the \hat{d}-\hat{q} coordinate system to obtain formula (2):

$$[ \begin{matrix}{u}_{\hat{d} h} \\ {u}_{\hat{q} h}\end{matrix} ] = [ \begin{matrix}{u}_{inj} \\ 0\end{matrix} ] \qquad formula ( 2 )$$

where u_{dh} is a \hat{d}-axis voltage, u_{\hat{q}h} is a \hat{q}-axis voltage, and Uᵢₙⱼ is an amplitude of the injected high-frequency voltage signal.

In some embodiments, voltages under the d-q coordinate system and the \hat{d}-\hat{q} coordinate system satisfy formula (3):

$$[ \begin{matrix}{u}_{dh} \\ {u}_{qh}\end{matrix} ] = T ( {\tilde{θ}}_{e} ) [ \begin{matrix}{u}_{\hat{d} h} \\ {u}_{\hat{q} h}\end{matrix} ] \qquad formula ( 3 )$$

where u_{dh} is a d-axis voltage, u_{qh} is a q-axis voltage, u_{\hat{d}h} is the d-axis voltage, u_{\hat{q}h} is the \hat{q}-axis voltage, and T(\tilde{θ}ₑ) is a period of injection of the high-frequency voltage signal.

In some embodiments, the period T(\tilde{θ}ₑ) of injecting the high-frequency voltage signal satisfies formula (4):

$$T ( {\tilde{θ}}_{e} ) = [ \begin{matrix}cos {\tilde{θ}}_{e} & sin {\tilde{θ}}_{e} \\ - sin {\tilde{θ}}_{e} & cos {\tilde{θ}}_{e}\end{matrix} ] \qquad formula ( 4 )$$

In addition, in some embodiments, a high-frequency current response signal of the motor 11 under the action of the high-frequency voltage signal satisfies formula (5):

$$[ \begin{matrix}{pi}_{dh} \\ {pi}_{qh}\end{matrix} ] = {[ \begin{matrix}{L}_{d} & 0 \\ 0 & {L}_{q}\end{matrix} ]}^{- 1} [ \begin{matrix}{u}_{dh} \\ {u}_{qh}\end{matrix} ] \qquad formula ( 5 )$$

where pi_{dh} is a d-axis current, pi_{qh} is a q-axis current, L_{d} is a d-axis equivalent inductance, and L_{q} is a q-axis equivalent inductance.

In some embodiments, a current in the d^{m}-q^{m} coordinate system satisfies formula (6A):

$$[ \begin{matrix}{i}_{dh}^{m} \\ {i}_{qh}^{m}\end{matrix} ] = T ( - ( {\tilde{θ}}_{e} + \frac{π}{4} ) ) [ \begin{matrix}{i}_{dh} \\ {i}_{qh}\end{matrix} ] \qquad formula ( 6 A )$$

where i_{dh}^{m} is a d^{m}-axis current, i_{qh}^{m} is a q^{m}-axis current, and T is a signal period.

In some embodiments, the current in the d-q coordinate system satisfies formula (6B):

$$[ \begin{matrix}{i}_{dh}^{\hat{}} \\ {i}_{qh}^{\hat{}}\end{matrix} ] = T ( - ( {\tilde{θ}}_{e} + \frac{π}{4} ) ) [ \begin{matrix}{i}_{dh} \\ {i}_{qh}\end{matrix} ] \qquad formula ( 6 B )$$

where i_{\hat{d}h} is a d-axis current, i_{\hat{q}h} is a \hat{q}-axis current, and T is a signal period.

Therefore, according to the formula (6A), a high-frequency current signal in the d^{m}-q^{m} coordinate system satisfies formula (7):

$$[ \begin{matrix}{pi}_{dh}^{m} \\ {pi}_{qh}^{m}\end{matrix} ] = \frac{{u}_{inj}}{\sqrt{2} ( {L}_{0}^{2} - {L}_{1}^{2} )} [ \begin{matrix}{L}_{0} - {L}_{1} ( cos ( 2 {\tilde{θ}}_{e} ) + sin ( 2 {\tilde{θ}}_{e} ) ) \\ {L}_{0} - {L}_{1} ( cos ( 2 {\tilde{θ}}_{e} ) - sin ( 2 {\tilde{θ}}_{e} ) )\end{matrix} ] \qquad formula ( 7 )$$

where L₁ is a q-axis inductance, and L₀ is a d-axis inductance.

Then, the high-frequency current signal in the d^{m}-q^{m} coordinate system is subjected to subtraction processing to obtain an observation error, and in the case where the observation error is smaller than a preset error threshold, polarity of the injected high-frequency voltage is considered, and the magnetic pole position error signal of the rotor 110 may be obtained by formula (8):

$$ε = \frac{( {L}_{0}^{2} - {L}_{1}^{2} )}{2 \sqrt{2} sgn ( {u}_{inj} ) {L}_{1} {T}_{s} {U}_{inj}} \cdot ( {I}_{qh}^{m} ( k ) - {I}_{qh}^{m} ( k - 1 ) ) - ( {I}_{dh}^{m} ( k ) - {I}_{dh}^{m} ( k - 1 ) ) \qquad formula ( 8 )$$

where ε is the obtained magnetic pole position error signal of the rotor 110, Tₛ is a sampling frequency of the discretized system, and I_{qh}^{m}(k) is a k-beat current sampling value.

In some embodiments, the magnetic pole position determining system 10 further includes a rotor position observer 15, the magnetic pole position determining apparatus 12 is further configured to: input the obtained magnetic pole position error signal to the rotor position observer 15 (e.g., PI-type position observer, i.e., proportional and integral type position observer) to obtain the initial magnetic pole position and the rotating speed of the rotor 110.

It should be noted that the magnetic pole initial position and the rotating speed of the rotor 110 are obtained by using the high-frequency square wave injection method, so that reliability is high and a dynamic performance is good. However, the observation result of the magnetic pole initial position of the rotor 110 obtained based on the high-frequency square wave injection method may converge to either the d-axis or the −d-axis. Therefore, the high-frequency square wave injection method cannot determine the magnetic pole position of the rotor 110. In this case, S102 is continuously executed.

At S102, a zero voltage vector pulse is applied to the motor 11 at a second time point t2.

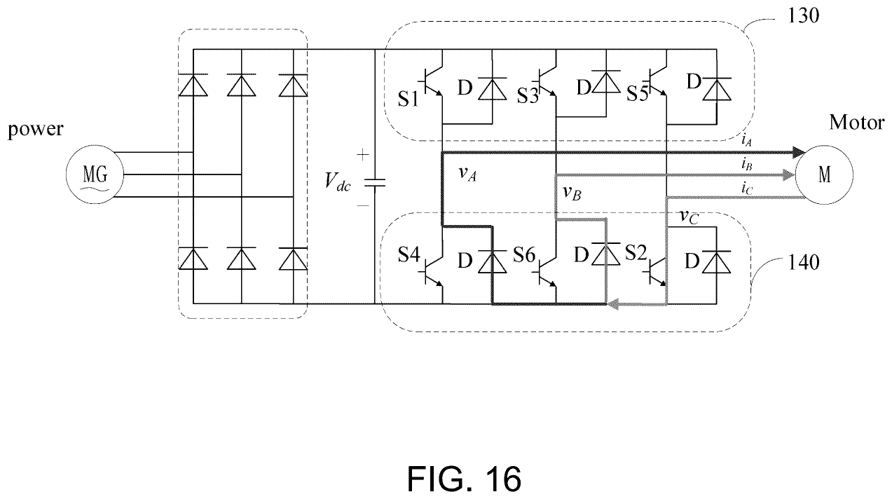

In some embodiments, as shown in FIG. 16, the motor 11 further includes an upper bridge arm 130 and a lower bridge arm 140, the upper bridge arm 130 and the lower bridge arm 140 being configured to control the current or provided voltage in the motor 11. For example, the upper bridge arm includes three power switch assemblies S1, S3, and S5, and the lower bridge arm includes three power switch assemblies S2, S4, and S6.

In some embodiments, the motor 11 further includes free-wheeling diodes D, the free-wheeling diodes D being configured to reduce an electrical stress (e.g., voltage stress or current stress) of a circuit of the motor 11 in a second direction and ensure that the circuit can function normally in the case of switching of the power switch assemblies.

In some embodiments, applying the zero voltage vector pulse to the motor 11 includes: when a stator phase current of the motor 11 is equal to zero, turning on the three power switch assemblies on the upper bridge arm or the lower bridge arm of the motor 11, and maintaining this state for a predetermined time, so that the three power switch assemblies and the free-wheeling diodes connected in parallel in the second direction form a conducting path.

It should be noted that the stator phase current of the motor 11 refers to a current flowing in the stator coil of the motor 11. With the stator phase current is equal to zero, the motor 11 is in an idling state, i.e., the motor 11 runs without a load.

At S103, a current vector position angle corresponding to the above zero voltage vector pulse is determined.

In the process of applying the zero voltage vector pulse to the motor 11, the stator winding is short-circuited, and a counter potential generated by the rotation of the rotor 110 induces a current vector i0 in the stator winding. In some embodiments, as shown in FIG. 6, the position of the current vector i0 in the two-phase stationary coordinate system is θ_{αβ}. In other words, the current vector position angle θ_{αβ} refers to the angle between the current vector i0 and the a-axis.

In some embodiments, θ_{αβ} satisfies formula (9):

$${θ}_{αβ} = {tan}^{- 1} ( {i}_{β} , {i}_{α} ) \qquad formula ( 9 )$$

where θ_{αβ} is an angle between the current vector i0 and the α-axis, i_{β} is a current of the β-axis, and i_{α} is a current of the a-axis.

In the case where the zero voltage vector pulse is applied to the motor 11, an equation of voltage of the motor 11 is, for example, formula (10):

$$[ \begin{matrix}{v}_{d} \\ {v}_{q}\end{matrix} ] = [ \begin{matrix}{R}_{s} & - ω {L}_{q} \\ ω {L}_{d} & {R}_{s}\end{matrix} ] [ \begin{matrix}{i}_{d} \\ {i}_{q}\end{matrix} ] + [ \begin{matrix}{L}_{d} & 0 \\ 0 & {L}_{q}\end{matrix} ] \frac{d}{dt} [ \begin{matrix}{i}_{d} \\ {i}_{q}\end{matrix} ] + [ \begin{matrix}0 \\ {ωψ}_{f}\end{matrix} ] = [ \begin{matrix}0 \\ 0\end{matrix} ] \qquad formula ( 10 )$$

where v_{d} is the d-axis voltage, v_{q} is the q-axis voltage, i_{d} is the d-axis current, i_{q} is the q-axis current, Rₛ is a stator resistance of the motor 11, ω is an electrical angular velocity of the rotor 110, ψ_{f} is a rotor excitation flux linkage, L_{q} is the q-axis inductance, and L_{d} is the d-axis inductance.

In some embodiments, an influence of the stator resistance Rₛ on the current vector i0 may be ignored due to a small voltage drop of the stator resistance Rₛ. In this case, formula (11) can be obtained from the formula (10):

$$i 0 = [ \begin{matrix}{i}_{d} \\ {i}_{q}\end{matrix} ] = [ \begin{matrix}- \frac{{ψ}_{f}}{{L}_{d}} ( 1 - cos ω T ) \\ - \frac{{ψ}_{f}}{{L}_{q}} sin ω T\end{matrix} ] \qquad formula ( 11 )$$

where i0 is the current vector, ψ_{f} is the rotor excitation flux linkage, ωT is an angle of rotation per unit time, i_{d} is the d-axis current, and i_{q} is the q-axis current.

Since the rotation angle ωT of the rotor 11 in a unit time is small, small approximation is performed on ωT, and then, according to the formula (11), the position of the current vector i0 in the d-q coordinate system is obtained as formula (12).

$${θ}_{dq} = {tan}^{- 1} ( {i}_{q} , {i}_{d} ) = \{ \begin{matrix}- \frac{{L}_{q}}{2 {L}_{d}} ω T - 90 ° , & ω > 0 \\ - \frac{{L}_{q}}{2 {L}_{d}} ω T + 90 ° , & ω < 0\end{matrix} \qquad formula ( 12 )$$

where θ_{dg} is an angle between the current vector i0 and the d-axis, ω is the electrical angular velocity of the rotor 110, i_{d} is the d-axis current, and i_{q} is the q-axis current.

In some embodiments, as shown in FIG. 6, when the motor 11 rotates in the first direction (e.g., Z direction in FIG. 6), ω>0, i_{d}<0, i_{q}<0, and |i_{q}| is greater than |i_{d}|, and in this case, it may be determined that the angle between the current vector i0 and the −q-axis is less than a preset angle threshold, and the current vector i0 lags behind the −q-axis. When the motor 11 rotates in the second direction (e.g., Y direction in FIG. 6), ω<0, i_{d}<0, i_{q}>0, and |i_{q}| is greater than |i_{d}|. In this case, it may be determined that the angle between the current vector i0 and the q-axis is less than the preset angle threshold, and the current vector i0 lags behind the q-axis.

It should be noted that a relationship between the current vector i0 excited by applying the zero voltage vector pulse to the motor 11 and the magnetic pole position of the rotor 110 is fixed, so that in some embodiments of the present disclosure, in the high-frequency square wave injection method, in the case where the observation result of the magnetic pole initial position of the rotor 110 is obtained, a magnetic pole direction and the magnetic pole position of the rotor 110 can be determined according to the fixed relationship between the current vector i0 and the magnetic pole position of the rotor 110.

In some embodiments of the present disclosure, the relationship between a position of the current vector i0 and the magnetic pole position of the rotor 110 is obtained by analyzing characteristics of components of the current vector i0 excited by applying a zero voltage vector single pulse to the motor 11 on the d-axis and the q-axis respectively. This relationship is independent of parameters of the motor 11, a rotor position, the rotating speed, etc. In this way, the zero voltage vector pulse is applied to the motor 11 and current sampling is performed, so as to obtain the position of the current vector, thereby realizing the identification of the magnetic pole position.

In some embodiments of the present disclosure, the proposed method of applying the zero voltage vector single pulse to the motor 11 can realize positioning of the current vector i0 by sampling the stator phase current and transforming a position thereof to the α-β coordinate system after the zero voltage vector single pulse is applied, thereby realizing the identification of the magnetic pole position. Thus, the magnetic pole position can be quickly identified, and the method of injecting the high-frequency voltage into the motor 11 is not limited.

At S104, the magnetic pole position of the rotor 110 is determined based on the first time point t1, the second time point t2, the rotating speed of the rotor 110, the current vector position angle, the preset mapping table, and the magnetic pole initial position.

The preset mapping table stores a correspondence between current vector position angles and quadrants in which the magnetic pole of the rotor 110 are located. The quadrant in which the magnetic pole of the rotor 110 is located can be found in the preset mapping table based on the current vector position angle. The quadrant is a quadrant where the d-axis of the rotor 110 and the q-axis of the rotor are located.

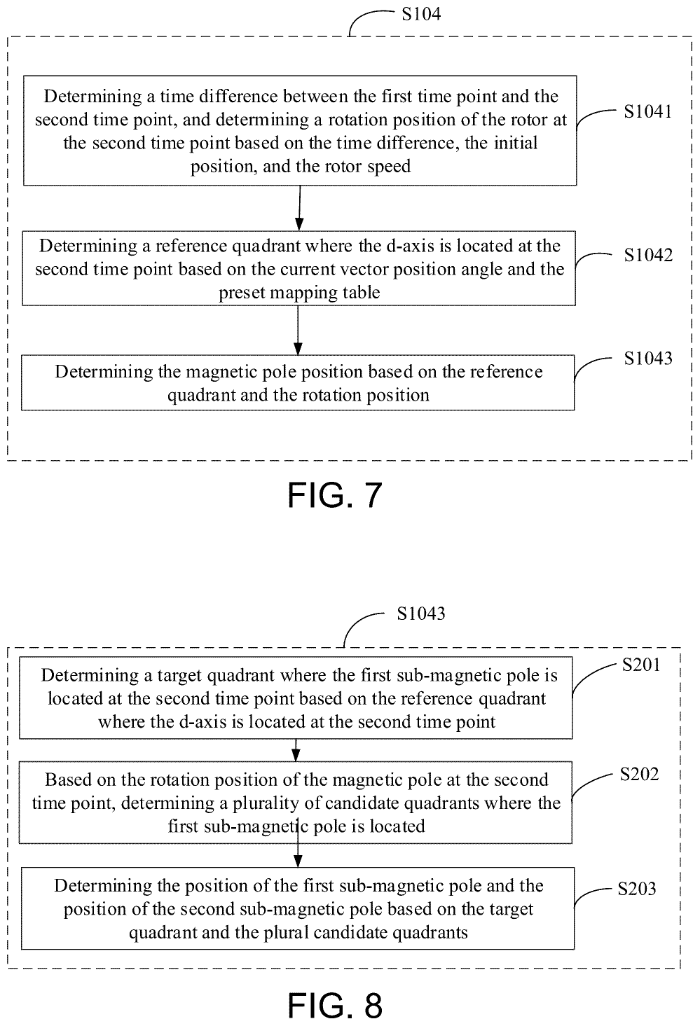

In some embodiments, as shown in FIG. 7, S104 includes S1041-S1043.

At S1041, a time difference between the first time point t1 and the second time point t2 is determined, and a rotation position of the magnetic pole at the second time point t2 is determined based on the time difference, the magnetic pole initial position, and the rotating speed of the rotor 110.

Here, the time difference between the first time point t1 and the second time point t2 is: t2−t1.

In some embodiments, the initial position of the magnetic pole at the first time point t1 is, for example, θHF, the rotating speed of the rotor 110 is, for example, ω, and when the zero voltage vector pulse is applied to the motor 11 at the second time point t2, the obtained rotation position of the magnetic pole of the rotor 110 at the second time point t2 is: θHF+ (t2−t1)ω.

At S1042, a reference quadrant where the d-axis is located at the second time point t2 is determined based on the current vector position angle and the preset mapping table.

In some embodiments, as shown in FIG. 6, the α-β stationary coordinate system divides a rotation plane of the magnetic pole into a first quadrant, a second quadrant, a third quadrant, and a fourth quadrant.

In some embodiments, the rotation positions of the magnetic pole include a magnetic pole position of the first sub-magnetic pole and a magnetic pole position of the second sub-magnetic pole. Here, as shown in FIG. 6, the position of the first sub-magnetic pole corresponds to, for example, the position of the d-axis, and the position of the second sub-magnetic pole corresponds to, for example, the position of the −d-axis.

In the method of performing the high-frequency square wave injection on the motor 11, in the case where the observation result of the magnetic pole initial position of the rotor 110 is obtained, the magnetic pole position determining apparatus 12 obtains the position of the first sub-magnetic pole and the position of the second sub-magnetic pole corresponding to the first time point t1.

The magnetic pole position determining apparatus 12 applies one zero voltage vector pulse to the motor 11 at the second time point t2, obtains the current vector position angle, and determines the position of the first sub-magnetic pole and the position of the second sub-magnetic pole of the rotor 110 corresponding to the second time point t2. Then, based on the current vector position angle and the preset mapping table, the quadrant where the d-axis is located is determined to determine the quadrant where the first sub-magnetic pole is located.

At S1043, the magnetic pole position is determined based on the reference quadrant and the rotation position of the magnetic pole at the second time point t2.

It can be understood that, since the motor 11 is in a low-speed rotation state, in the case where the time difference between the first time point t1 and the second time point t2 is obtained, the rotation positions of the first sub-magnetic pole and the second sub-magnetic pole at the second time point t2 are determined based on the time difference, the magnetic pole initial position of the rotor 110, and the rotor speed, and an angle range where the d-axis is located at the second time point t2 is determined based on the characteristics of the zero voltage vector single pulse. Further, whether the observation result of the magnetic pole initial position converges to the d-axis or the −d-axis is determined based on the angle range where the d-axis is located at the second time point t2 and the rotation positions of the first sub-magnetic pole and the second sub-magnetic pole.

In some embodiments, as shown in FIG. 8, S1043 includes S201-S203.

At S201, a target quadrant where the current vector i0 is located at the second time point t2 is determined based on the reference quadrant where the d-axis is located at the second time point t2.

It should be noted that the quadrant where the current vector i0 is located is the target quadrant.

At S202, based on the rotation position of the magnetic pole at the second time point t2, a plurality of candidate quadrants where the first sub-magnetic pole is located are determined.

At S203, the position of the first sub-magnetic pole and the position of the second sub-magnetic pole are determined based on the target quadrant and the plurality of candidate quadrants.

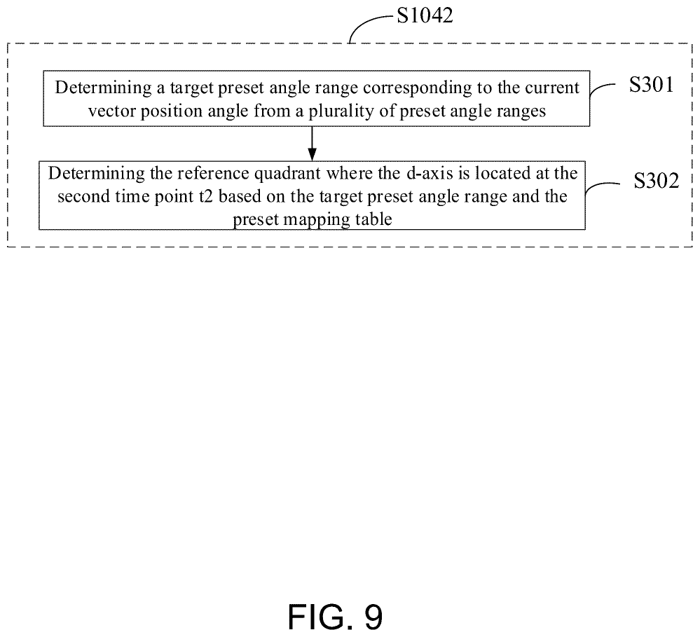

In some embodiments, in order to avoid incorrect identification of the magnetic pole position, as shown in FIG. 9, in some embodiments of the present disclosure, S1042 includes S301-S302.

At S301, a target preset angle range corresponding to the current vector position angle is determined from a plurality of preset angle ranges.

The target preset angle range corresponding to the current vector position angle is the angle range in which the current vector position angle is located.

Here, the d-axis is located in each of the plurality of preset angle ranges.

In some embodiments, the plurality of preset angle ranges include, for example: (315°, 45°), (45°, 135°), (135°, 225°), and (225°, 315°).

It should be noted that, as shown in FIG. 6, in the case where the rotor 110 rotates in the first direction and the current vector excited by the zero voltage vector pulse applied to the motor 11 is located in the first quadrant, the first sub-magnetic pole may be located in the second quadrant or the third quadrant, and the second sub-magnetic pole may be located in the first quadrant or the fourth quadrant.

In some embodiments, in the case where the zero voltage vector pulse is applied to the motor 11, if the current vector is located in the first quadrant and close to the β-axis, i.e., i_{α} is close to 0, the first sub-magnetic pole is located in the second quadrant.

If i_{α} is erroneously determined to be negative due to the small current and poor sampling precision, the quadrant in which the current vector is located is erroneously determined as the second quadrant. As shown in FIG. 6, in the case where the motor 11 rotates in the first direction and the current vector is located in the second quadrant, the first sub-magnetic pole may be located in a quadrant other than the second quadrant, resulting in erroneous identification of the magnetic pole position of the motor 11.

In some embodiments, the range in which the current vector is located is divided into (315°, 45°), (45°, 135°), (135°, 225°), and (225°, 315°), so that the corresponding angle range in the quadrant in which the current vector is located can be narrowed to solve the problem that i_{α} is erroneously determined due to the small current and the poor sampling precision.

In some other embodiments, the range in which the current vector is located may be divided into (316°, 45°), (45°, 135°), (135°, 225°) and (225°, 316°).

At S302, the reference quadrant where the d-axis is located at the second time point t2 is determined based on the target preset angle range and the preset mapping table.

Here, the preset mapping table includes a plurality of preset angles and the reference quadrant corresponding to each preset angle.

In some embodiments, if it is determined that the motor 11 rotates in the first direction, the quadrants in which the d-axis is located are determined to be the first quadrant and the second quadrant based on the current vector position angle and a first sub-preset mapping table.

In the case where the motor 11 rotates in the first direction, the preset mapping table includes, for example, the first sub-preset mapping table (i.e., table 1), which shows magnetic pole position information when the current vector is at different position intervals.

TABLE 1
first sub-preset mapping table

| region where current | quadrant where d-axis | quadrant where −d-axis |
|---|---|---|
| vector is located | (N pole) is located | (S pole) is located |
| (315°, 45°) | 1, 2 | 3, 4 |
| (45°, 135°) | 2, 3 | 4, 1 |
| (135°, 225°) | 3, 4 | 1, 2 |
| (225°, 315°) | 4, 1 | 2, 3 |

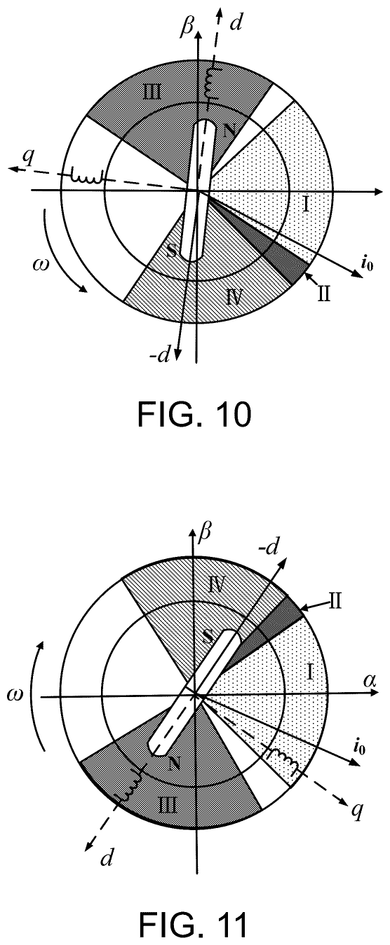

In some embodiments, as shown in FIG. 10, in the case where the motor 11 rotates in the first direction and the current vector i0 is located in the range (315°, 45°) (i.e., region I and region II in FIG. 10), that is, the current vector i0 is close to θ_{αβ}=k×45°, (k=1, 2), erroneous determination of the region where the magnetic pole is located may be caused due to proximity of values of i_{α} and i_{β}. For example, θ_{αβ}=40° may be erroneously determined to be θ_{αβ}=50°. The actual positions of the d-axis are all located within the second quadrant and are located within and outside a region III in FIG. 10 respectively. If an angle where the current vector is located is erroneously determined to be θ_{αβ}=50°, the current vector i0 belongs to the range (45°, 135°). According to the first sub-preset mapping table, when the current vector is within the range (45°, 135°) and the rotor is in the second quadrant, the position of the rotor is still determined to be the d-axis, that is, the identification result of the magnetic pole position of the rotor is the N pole, and is consistent with the identification result of the magnetic pole position when no erroneous determination occurs.

In the case where the motor 11 rotates in the second direction or erroneous determination of the region where the current vector is located occurs at other angles, a determination process coincides with the above-described determination process. Thus, by adopting the magnetic pole position determining method according to the present disclosure, in a certain range, even if the positive-negative or the magnitude relationship of i_{α} and i_{β} are incorrectly determined, the accurate identification of the magnetic pole position can still be realized.

In the case where the current vector is in the range (315°, 45°), the magnetic pole position (d-axis) may be located in partial regions (e.g., region III in FIG. 10) in the first quadrant and the second quadrant based on the above constructed geometric relationship. The −d-axis may be located in partial regions (e.g., regions II and IV in FIG. 10) in the third quadrant and the fourth quadrant. It can be determined that the current vector is in the range (315°, 45°) according to i_{α}>0 and i_{α}>|i_{β}|. Therefore, a magnetic pole position identification strategy can be established according to this rule. That is, if the current vector is determined to be in the range (315°, 45°) according to i_{α}>0 and i_{α}>|i_{β}|, the quadrant where the rotor position obtained by the high-frequency injection method is located is further determined. If the rotor position is in at least one of the first quadrant and the second quadrant, the magnetic pole is the N pole; and if the rotor position quadrant is in at least one of the third quadrant and the fourth quadrant, the magnetic pole is the S pole.

In some embodiments, if it is determined that the rotation direction of the rotor is the second direction, the quadrants in which the d-axis is located are determined to be the third quadrant and the fourth quadrant based on the current vector position angle and the second sub-preset mapping table.

In the case where the motor 11 rotates in the second direction, the preset mapping table further includes, for example, the second sub-preset mapping table (i.e., table 2), which shows the magnetic pole position information when the current vector is at different position intervals.

TABLE 2
second sub-preset mapping table

| region where current | quadrant where d-axis | quadrant where −d-axis |
|---|---|---|
| vector is located | (N pole) is located | (S pole) is located |
| (315°, 45°) | 3, 4 | 1, 2 |
| (45°, 135°) | 4, 1 | 2, 3 |
| (135°, 225°) | 1, 2 | 3, 4 |
| (225°, 315°) | 2, 3 | 4, 1 |

In some embodiments, the magnetic pole position determining method according to the present disclosure further includes: in the case where the first sub-magnetic pole of the rotor 110 converges to a target magnetic pole, compensating the current vector position angle of the rotor 110 according to a preset angle.

The target magnetic pole is the position of the first sub-magnetic pole at the second time point.

In some embodiments, as shown in FIG. 11, in the case where the current vector is within the range (315°, 45°) (for example, regions I and II in FIG. 11), the magnetic pole positions (d-axis) may be located in partial regions of the third quadrant and the fourth quadrant (for example, region III in FIG. 11) according to the above constructed geometric relationship. The −d-axis may be located in partial regions in the first quadrant and the second quadrant (e.g., regions II and IV in FIG. 11).

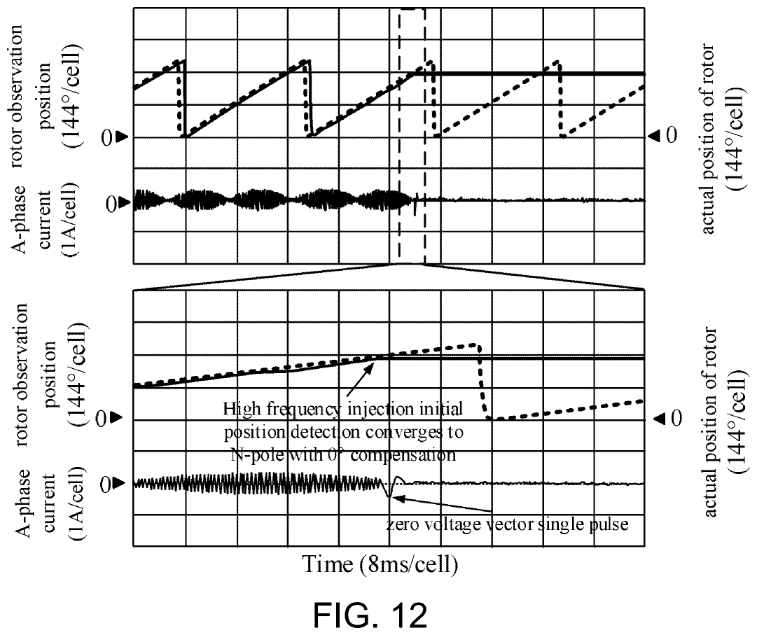

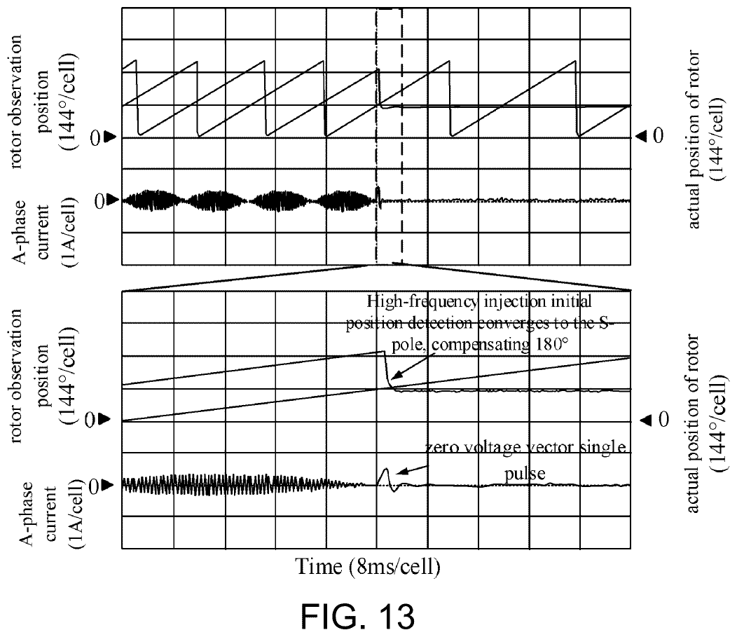

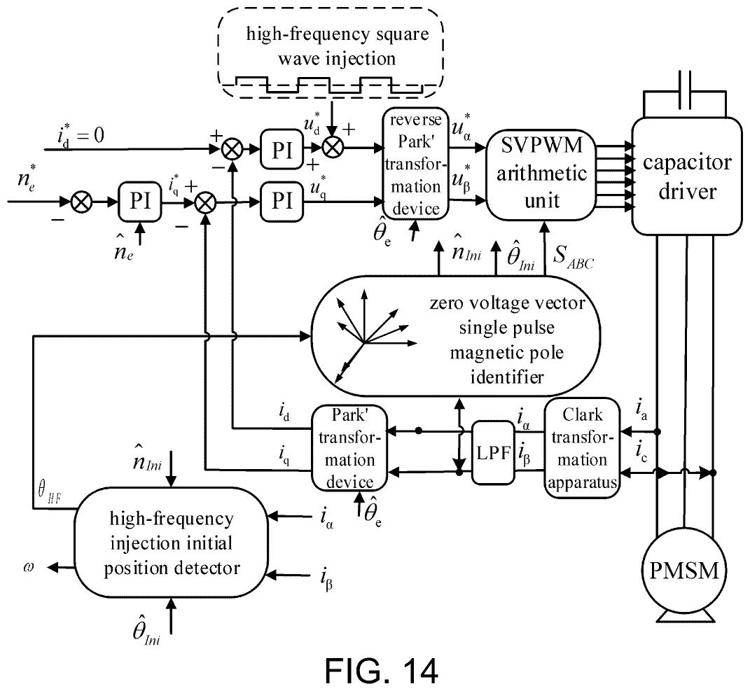

In some embodiments, as shown in FIG. 12 and FIG. 13, a permanent-magnet synchronous motor with a power of 2.2 kW is used as the control motor, a coupler is coaxially coupled to a loading motor, and the two frequency converters are coupled by using a common direct current bus. A vector control algorithm is realized through a microprocessor (such as an ARM embedded processor) to control the permanent-magnet synchronous motor. A switching frequency of the inverter of the permanent-magnet synchronous motor is 6 kHz. Here, main parameters of the used permanent-magnet synchronous motor are, for example: a rated power of 2.2 kW, a rated current of 5.6 A, a rated rotating speed of 1,500 r/min, a d-axis inductance Ld=22.4 mH, a q-axis inductance Lq=51.8 mH, a pole pair number P=3, and the stator resistance Rₛ=1.88Ω.

As shown in FIG. 12, in some embodiments, the initial position of the magnetic pole is first observed using salient pole characteristics of the permanent-magnet synchronous motor with the high-frequency injection method. Then, the zero voltage vector single pulse is applied to the motor to excite a stator current vector, and the magnetic pole position is identified according to the magnetic pole position determining method according to the disclosure. If the observation result obtained by using the high-frequency injection method converges to the S pole (i.e., −d-axis), 180° compensation is performed, thereby obtaining an accurate position of the rotor. If the observation result obtained by using the high-frequency injection method converges to the N pole (i.e., d-axis), no compensation is required. Here, an amplitude of the current vector excited by the zero voltage vector pulse is controlled to be 0.5 A.

As shown in FIG. 12, in some embodiments, the initial position of the magnetic pole is observed using the high-frequency injection method at the first time point, and the zero voltage vector pulse is applied to the motor at t=40 ms (i.e., the second time point) to complete the identification of the magnetic pole position. An amplitude of an A-phase stator current excited by the zero voltage vector pulse is 0.5 A, for example, and normal operation of the motor is not influenced. In FIG. 12, the identification result of the magnetic pole position is the N pole, and therefore, the angle compensation is not required. The identification process takes about 3 ms.

As shown in FIG. 13, in some embodiments, the initial position of the magnetic pole is observed using the high-frequency injection method at the first time point, and the zero voltage vector pulse is applied to the motor at t=40 ms (i.e., the second time point) to perform the identification of the magnetic pole position. The amplitude of the A-phase stator current excited by the zero voltage vector pulse is 0.5 A, for example, and the identification process of the magnetic pole position takes about 3 ms. In FIG. 13, the identification result of the magnetic pole position is the S pole, and 180° compensation is required on the basis of the observation result of the magnetic pole initial position, so that the correct initial position is obtained.

As shown in FIG. 14, in some embodiments, a principle architecture of the magnetic pole position determining system includes a zero voltage vector single pulse magnetic pole position determining apparatus (i.e., magnetic pole position determining apparatus 12), a permanent-magnet synchronous motor (i.e., motor 11), and a PI controller (i.e., proportional-integral controller).

In some embodiments, the principle architecture of the magnetic pole position determining system further includes a reverse Park's transformation device configured to transform and output the voltage.

In some embodiments, the principle architecture of the magnetic pole position determining system further includes a space vector pulse width modulation arithmetic apparatus in which an ideal flux linkage circle of a three-phase symmetric motor stator when a three-phase symmetric sine wave voltage is used for supplying power is mainly taken as a reference standard, and different switch modes of a three-phase inverter are switched, so as to form a PWM wave, i.e., a pulse width modulation waveform, and an accurate flux linkage circle is tracked by a formed actual flux linkage vector.

In some embodiments, the principle architecture of the magnetic pole position determining system further includes a low-pass filter configured to obtain a signal with a required frequency through filtering.

In some embodiments, the principle architecture of the magnetic pole position determining system further includes a capacitor driver configured to implement variable frequency driving.

In some embodiments, the principle architecture of the magnetic pole position determining system further includes a Clark transformation apparatus. The Clark transformation apparatus is configured to transform currents Iₐ, I_{b}, and I_{c} in a three-phase static coordinate system of the motor 101 to currents I_{α} and I_{β} in the two-phase static coordinate system.

In some embodiments, the principle architecture of the magnetic pole position determining system further includes a Park' transformation apparatus 129 configured to transform the currents Iₐ and I_{β} in the two-phase stationary coordinate system to currents I_{d} and I_{q} in a two-phase rotating coordinate system.

i_{d}* is a d-axis current given value, and i_{d} is a d-axis current feedback value. i_{q}* is a q-axis current given value, and i_{q} is a q-axis current feedback value. u_{d}* is a d-axis voltage value; and u_{q}* is a q-axis voltage value. u_{α}* is an a-axis voltage, and u_{β}* is a β-axis voltage. iₐ and i_{c} are collected two-phase stator currents. i_{α} is an a-axis current feedback value, and i_{β} is a β-axis current feedback value. θ_{HF} is the initial position calculated using the high-frequency injection method, and ω is the rotating speed calculated using the high-frequency injection method. \hat{θ}_{Ini} is the initial position output after the magnetic pole position identification is completed; and \hat{n}_{Ini} is the rotating speed observation result after the magnetic pole identification is completed. \hat{θ}ₑ is the rotor position in a vector control system; \hat{n}ₑ is a rotating speed feedback value in the vector control system; and S_{ABC} is an inverter instruction corresponding to the zero voltage vector pulse.

Here, the high-frequency square wave voltage is injected to the d-axis voltage output from the voltage regulator to complete determination of the position of the magnetic pole of the rotor 110 by the magnetic pole position determining system 100.

In the magnetic pole position determining method according to some embodiments of the present disclosure, a magnetic pole position identification solution under the conditions that the motor 110 rotates forwards and reversely and the d-axis of the rotor and the current vector are located in different position regions is constructed according to the relationship between the current vector excited by the zero voltage vector pulse and the position of the rotor 110 in conjunction with the observation result of the initial position of the rotor 110 obtained based on the high-frequency voltage injection method. In the determining method according to the present disclosure, the identification of the magnetic pole position can be completed only by applying one zero voltage vector pulse, and the determination of the region where the current vector is located can be completed only by carrying out positive and negative judgment and size comparison on the collected i_{α} and i_{β}, so that a precise requirement for current sampling is low, and the identification speed is high.

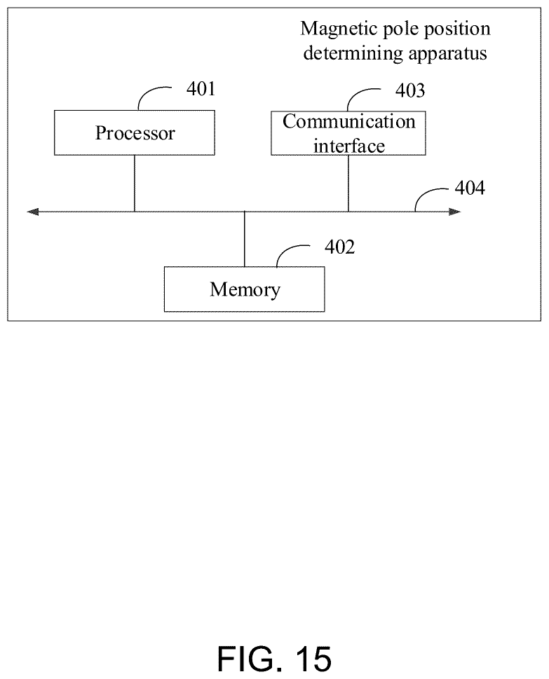

The present disclosure further provides a schematic hardware structure diagram of the magnetic pole position determining apparatus. In some embodiments, as shown in FIG. 15, the magnetic pole position determining apparatus 12 includes a processor 401.

The processor 401 may be a central processing unit (CPU), a general purpose processor network processor (NP), a digital signal processor (DSP), a microprocessor, a microcontroller, a programmable logic device (PLD), or any combination thereof.

In some embodiments, the magnetic pole position determining apparatus 12 further includes a memory 402 and a communication interface 403 coupled to the processor 401. The processor 401, the memory 402, and the communication interface 403 are coupled by a bus 404.

The memory 402 may contain a computer program code. The processor 401 is capable of executing the computer program code stored in the memory 402 to implement the magnetic pole position determining method of a magnetic pole position determining system according to the present disclosure.

The communication interface 403 may be configured to be communicated with other devices or communication networks (for example, an Ethernet, a radio access network (RAN), wireless local area networks (WLAN), or the like).

The bus 404 may be a peripheral component interconnect (PCI) bus, an extended industry standard architecture (EISA) bus, or the like. The bus 404 is represented only by one thick line in FIG. 15, but which does not indicate only one bus or one type of buses.

It will be understood by those skilled in the art that the scope of the disclosure of the present application is not limited to the particular embodiments described above, and that modifications and substitutions of certain elements of the embodiments may be made without departing from the spirit of the application. The scope of the present application is limited by the appended claims.

What is claimed is:

1. A magnetic pole position determining system, comprising:
a motor comprising a rotor, the rotor comprising a magnetic pole;
a magnetic pole position determining apparatus coupled to the motor, wherein the magnetic pole position determining apparatus is configured to:
apply a high-frequency voltage to a direct axis of a two-phase rotating coordinate system of the motor at a first time point;
determine a magnetic pole initial position of the rotor and a rotating speed of the rotor based on the high-frequency voltage;
apply a zero voltage vector pulse to the motor at a second time point;
determine a current vector position angle corresponding to the zero voltage vector pulse;
determine a rotation position of the magnetic pole at the second time point based on a time difference between the first time point and the second time point, the rotating speed of the rotor, and the magnetic pole initial position;
determine a reference quadrant where the direct axis is located at the second time point based on the current vector position angle and a preset mapping table, wherein the preset mapping table stores a correspondence between the current vector position angle and a quadrant in which the magnetic pole of the rotor is located, the quadrant being a quadrant formed by axes of a two-phase stationary coordinate system of the motor; and
determine a magnetic pole position based on the reference quadrant where the direct axis is located at the second time point and the rotation position of the magnetic pole at the second time point.

2. The magnetic pole position determining system according to claim 1, wherein the magnetic pole comprises a first sub-magnetic pole and a second sub-magnetic pole, and the rotation position comprise a magnetic pole position of the first sub-magnetic pole and a magnetic pole position of the second sub-magnetic pole;
determining the magnetic pole position based on the reference quadrant where the direct axis is located at the second time point and the rotation position of the magnetic pole at the second time point comprises:
determining a target quadrant where the current vector is located at the second time point based on the reference quadrant;
determining a plurality of candidate quadrants corresponding to the current vector based on the rotation position; and
determining the position of the first sub-magnetic pole and the position of the second sub-magnetic pole based on the target quadrant and the plural of candidate quadrants, wherein a quadrant where the position of the first sub-magnetic pole is located corresponds to the target quadrant.

3. The magnetic pole position determining system according to claim 1, wherein determining the reference quadrant where the direct axis is located at the second time point based on the current vector position angle and the preset mapping table comprises:
determining a target preset angle range corresponding to the current vector position angle from a plurality of preset angle ranges, wherein the direct axis is located in each of the plurality of preset angle ranges; and
determining the reference quadrant where the direct axis is located at the second time point based on the target preset angle range and the preset mapping table.

4. The magnetic pole position determining system according to claim 3, wherein the preset mapping table comprises a first sub-preset mapping table and a second sub-preset mapping table;
determining the reference quadrant where the direct axis is located at the second time point based on the current vector position angle and the preset mapping table comprises:
when the rotor rotates in a first direction, determining that the quadrant where the direct axis is located at the second time point is a first quadrant and a second quadrant based on the current vector position angle and the first sub-preset mapping table; and
when the rotor rotates in a second direction, determining that the quadrant where the direct axis is located at the second time point is a third quadrant and a fourth quadrant based on the current vector position angle and the second sub-preset mapping table;
wherein the second direction is opposite to the first direction.

5. The magnetic pole position determining system according to claim 4, wherein the motor further comprises:
an upper bridge arm, the upper bridge arm comprising three power switch assemblies;
a lower bridge arm, the lower bridge arm comprising three power switch assemblies; and
free-wheeling diodes configured to reduce an electrical stress of a circuit of the motor in the second direction;
wherein applying the zero voltage vector pulse to the motor at the second time point comprises:
on a condition that a stator phase current of the motor is determined to be equal to zero, turning on the three power switch assemblies of the upper bridge arm or turning on the three power switch assemblies of the lower bridge arm, and maintaining for a preset time.

6. The magnetic pole position determining system according to claim 2, wherein the magnetic pole position determining apparatus is further configured to: when a first sub-magnetic pole of the rotor is determined to be converged to a target magnetic pole, compensate the current vector position angle of the rotor according to a preset angle.

7. The magnetic pole position determining system according to claim 1, further comprising a voltage regulator, the voltage regulator being coupled to the magnetic pole position determining apparatus and configured to regulate an output voltage of the motor;
wherein applying the high-frequency voltage to the direct axis of the two-phase rotating coordinate system of the motor at the first time point comprises:
adding, by the magnetic pole position determining apparatus, the high-frequency voltage to a direct-axis voltage output by the voltage regulator.

8. The magnetic pole position determining system according to claim 7, wherein the high-frequency voltage is a square wave signal with symmetric positive and negative half-cycles.

9. The magnetic pole position determining system according to claim 1, further comprising an inverter, the inverter being coupled to the magnetic pole position determining apparatus and configured to convert a direct current into an alternating current;
wherein determining the magnetic pole initial position of the rotor and the rotating speed of the rotor based on the high-frequency voltage comprises: obtaining, by the magnetic pole position determining apparatus, the magnetic pole initial position of the rotor and the rotating speed of the rotor according to a feedback value of a three-phase current output by the inverter.

10. The magnetic pole position determining system according to claim 9, further comprising a rotor position observer, the rotor position observer being coupled to the magnetic pole position determining apparatus;
wherein determining the magnetic pole initial position of the rotor and the rotating speed of the rotor based on the high-frequency voltage further comprises:
obtaining a magnetic pole position error signal based on the high-frequency voltage and the feedback value of the three-phase current; and
inputting the magnetic pole position error signal into the rotor position observer to obtain the magnetic pole initial position of the rotor and the rotating speed of the rotor.

11. A magnetic pole position determining method, applied to a motor, the motor comprising a rotor, the rotor comprising a magnetic pole;
wherein the magnetic pole position determining method comprises:
applying a high-frequency voltage to a direct axis of a two-phase rotating coordinate system of the motor at a first time point;
determining a magnetic pole initial position of the rotor and a rotating speed of the rotor based on the high-frequency voltage;
applying a zero voltage vector pulse to the motor at a second time point;
determining a current vector position angle corresponding to the zero voltage vector pulse;
determining a rotation position of the magnetic pole at the second time point based on a time difference between the first time point and the second time point, the rotating speed of the rotor, and the magnetic pole initial position;
determining a reference quadrant where the direct axis is located at the second time point based on the current vector position angle and a preset mapping table, wherein the preset mapping table stores a correspondence between the current vector position angle and a quadrant in which the magnetic pole of the rotor is located, the quadrant being a quadrant formed by axes of a two-phase stationary coordinate system of the motor; and
determining a magnetic pole position based on the reference quadrant where the direct axis is located at the second time point and the rotation position of the magnetic pole at the second time point.

12. The method according to claim 11, further comprising: when a first sub-magnetic pole of the rotor is determined to be converged to a target magnetic pole, compensating the current vector position angle of the rotor according to a preset angle.

13. The method according to claim 11, wherein the magnetic pole comprises a first sub-magnetic pole and a second sub-magnetic pole;
the rotation positions comprise a magnetic pole position of the first sub-magnetic pole and a magnetic pole position of the second sub-magnetic pole;
determining the magnetic pole position based on the reference quadrant where the direct axis is located at the second time point and the rotation position of the magnetic pole at the second time point comprises:
determining a target quadrant where the first sub-magnetic pole is located at the second time point based on the reference quadrant;
determining a plurality of candidate quadrants where the first sub-magnetic pole is located based on the rotation position; and
determining the position of the first sub-magnetic pole and the position of the second sub-magnetic pole based on the target quadrant and the plural of candidate quadrants; wherein a quadrant where the position of the first sub-magnetic pole is located corresponds to the target quadrant.

14. The method according to claim 11, wherein determining the reference quadrant where the direct axis is located at the second time point based on the current vector position angle and the preset mapping table comprises:
determining a target preset angle range corresponding to the current vector position angle from a plurality of preset angle ranges; wherein the direct axis is located in each of the plurality of preset angle ranges; and
determining the reference quadrant where the direct axis is located at the second time point based on the target preset angle range and the preset mapping table.

15. The method according to claim 14, wherein the preset mapping table comprises a first sub-preset mapping table and a second sub-preset mapping table;
determining the reference quadrant where the direct axis is located at the second time point based on the current vector position angle and the preset mapping table comprises:
when the rotor rotates in a first direction, determining that the quadrant where the direct axis is located at the second time point is a first quadrant and a second quadrant based on the current vector position angle and the first sub-preset mapping table; and
when the rotor rotates in a second direction, determining that the quadrant where the direct axis is located at the second time point is a third quadrant and a fourth quadrant based on the current vector position angle and the second sub-preset mapping table;
wherein the second direction is opposite to the first direction.

16. The method according to claim 15, wherein the motor further comprises:
an upper bridge arm, the upper bridge arm comprising three power switch assemblies;
a lower bridge arm, the lower bridge arm comprising three power switch assemblies; and
free-wheeling diodes configured to reduce an electrical stress of a circuit of the motor in the second direction;
wherein applying the zero voltage vector pulse to the motor at the second time point comprises:
on a condition that a stator phase current of the motor is determined to be equal to zero, turning on the three power switch assemblies of the upper bridge arm or turning on the three power switch assemblies of the lower bridge arm, and maintaining for a preset time.

17. The method according to claim 11, wherein the magnetic pole position determining system further comprises:
a voltage regulator, the voltage regulator being coupled to the magnetic pole position determining apparatus and configured to regulate an output voltage of the motor;
wherein applying the high-frequency voltage to the direct axis of the two-phase rotating coordinate system of the motor at the first time point comprises:
adding, by the magnetic pole position determining apparatus, the high-frequency voltage to a direct-axis voltage output by the voltage regulator.

18. The method according to claim 11, wherein the magnetic pole position determining system further comprises:
an inverter, the inverter being coupled to the magnetic pole position determining apparatus and configured to convert a direct current into an alternating current;
determining the magnetic pole initial position of the rotor and the rotating speed of the rotor based on the high-frequency voltage comprises: obtaining, by the magnetic pole position determining apparatus, the magnetic pole initial position of the rotor and the rotating speed of the rotor according to a feedback value of a three-phase current output by the inverter.

19. The method according to claim 18, wherein the magnetic pole position determining system further comprises a rotor position observer, the rotor position observer being coupled to the magnetic pole position determining apparatus;
wherein determining the magnetic pole initial position of the rotor and the rotating speed of the rotor based on the high-frequency voltage further comprises:
obtaining a magnetic pole position error signal based on the high-frequency voltage and the feedback value of the three-phase current; and
inputting the magnetic pole position error signal into the rotor position observer to obtain the magnetic pole initial position of the rotor and the rotating speed of the rotor.

20. The method according to claim 11, wherein the high-frequency voltage is a square wave signal with symmetric positive and negative half-cycles.
